(19) United States
(12) Patent Application Publication
(10) Pub. No.: US 2025/0020545 A1
(43) Pub. Date: Jan. 16, 2025

(54) METHOD FOR AUTOMATICALLY DIAGNOSING A PART

(71) Applicant: SAFRAN AIRCRAFT ENGINES, PARIS (FR)

(72) Inventors: Abdallah EL HIDALI, MOISSY CRAMAYEL (FR); Julien Christian Pascal GRIFFATON, MOISSY CRAMAYEL (FR)

(21) Appl. No.: 18/713,562

(22) PCT Filed: Dec. 1, 2022
(86) PCT No.: PCT/FR2022/052216

§ 371 Date: May 24, 2024

(30) Foreign Application Priority Data
Dec. 2, 2021 (FR) 2112840

(51) Int. Cl. G01M 15/14

(52) U.S. Cl. CPC G01M 15/14

(57) ABSTRACT

A method for automatically diagnosing a part of a rotating machine based on a time signal generated by the rotating machine, includes constructing a diagram from the signal, including the following procedures: splitting the signal into a plurality of sub-signals; for each sub-signal, calculating the Fourier transform of the sub-signal to obtain a vibratory energy per frequency; constructing the diagram, the diagram being a matrix having rows each corresponding to a speed of rotation of the rotating machine, and columns each corresponding to a frequency of the Fourier transform divided by a speed of rotation of the rotating machine, the matrix including, for each row and each column, the corresponding vibratory energy; supervised training of an artificial neural network to provide, from a diagram, an operating class included in a set of operating classes including at least one nominal operating class and one defective operating class, using the trained network.

### TECHNICAL FIELD OF THE INVENTION

The technical field of the invention is that of the diagnosis of parts and more particularly that of the automatic diagnosis of parts.

The present invention relates to a method for automatically diagnosing a part of a rotating machine from a non-stationary time signal generated by the rotating machine. The present invention also relates to a calculator, a computer program product and a recording medium.

### TECHNOLOGICAL BACKGROUND OF THE INVENTION

In many industrial sectors, the diagnosis of systems, for example of rotating machines, is essential in order to know their operating state or health and thus to plan maintenance operations so as to minimise their unavailability.

The diagnosis of a system is conventionally carried out by analysing physical signals generated by the system, which can be measured by sensors, for example electrical, magnetic, thermal, acoustic or vibrational.

In particular, the analysis of vibratory signals is commonly used to determine the operating state of rotating machine components, for example of their bearings: during production or maintenance phases, high-frequency vibratory signals are thus acquired when the rotating machine is operating, in order to detect weak signals characteristic of bearing damage, known as signatures, and thus prevent a failure of the rotating machine.

Nowadays, the vibratory signals acquired are analysed by calculating statistical indicators from the vibratory signals in the order domain of a rotation velocity. The statistical indicators calculated are then compared with statistical indicators representative of a population of rotating machines without damage, the damage detection thresholds, that is, the deviation values considered synonymous with damage, being determined empirically and subjectively by experts. Thus, diagnosis is unreliable since it can vary from one expert to another and requires the intervention of specialists.

There is therefore a need to reliably diagnose a part of a system, and more particularly of a rotating machine, while limiting the number of human interventions.

### SUMMARY OF THE INVENTION

The invention provides a solution to the problems previously discussed, by making it possible to provide reliable and automatic diagnosis of a part of a rotating machine.

A first aspect of the invention relates to a method for automatically diagnosing a part of a rotating machine carried out from a non-stationary time signal generated by the rotating machine during at least one phase during which a rotation speed of the rotating machine varies as a function of time, the method including the following steps of:
Building a diagram from the signal, comprising the following sub-steps of:
   Splitting the signal into a plurality of sub-signals, each sub-signal corresponding to a time interval associated with at least one rotation speed of the rotating machine and being quasi-stationary over the time interval;
   For each sub-signal, calculating the Fourier transform of the sub-signal in order to obtain a vibratory energy for each frequency of the Fourier transform of the sub-signal;
   Building the diagram, the diagram being a matrix having a plurality of rows each corresponding to a rotation speed of the rotating machine, ordered in ascending order, and a plurality of columns each corresponding to a frequency of the Fourier transform divided by a rotation speed of the rotating machine, ordered in ascending order, the matrix comprising, for each row and each column, the vibratory energy of the sub-signal corresponding to the rotation speed of the rotating machine of the row for the frequency of the Fourier transform of the column;
Supervisedly training an artificial neural network to obtain an artificial neural network trained capable of providing, from a diagram, class of operation included in a set of classes of operation including at least one class of nominal operation and one class of defective operation, the artificial neural network being trained on a training database including a plurality of training diagrams, each training diagram being built from a non-stationary time signal generated by a training rotating machine and being associated with a class of operation from the set of classes of operation;
Using the artificial neural network trained on the diagram built to provide a class of operation of the rotating machine.

By means of the invention, the diagnosis of a part of a rotating machine is automated, since once the classes of operation of the training database have been obtained, no human intervention is necessary. For this, building of a diagram representing the vibratory energy of the time signal as a function of the frequency and rotation speed of the rotating machine provides an image that can be supplied to an artificial neural network specialising in image processing, to detect signatures in the diagram that are synonymous with damage and thus to determine a class of operation for the part, that is, to determine whether or not the part is defective. The time signal is processed for different rotation speeds because damage can occur at only part of the rotation speeds taken by the rotating machine.

As part of the experiments described below for diagnosing an aircraft engine bearing, the artificial neural network trained provides 96.25% accurate results with a 95% rate of detection of defective engines and a 2.5% false alarm rate and bases its decision on the zones of the diagram corresponding to the signatures conventionally used by experts to make their diagnosis. The diagnosis provided by the method according to the invention can therefore be considered reliable.

In addition to the characteristics just discussed in the previous paragraph, the method according to the present invention may have one or several complementary characteristics from the following, considered individually or according to any technically possible combinations:
the signal is a vibratory signal.
the part is a bearing included in the rotating machine.
the rotating machine is an engine.
the step of building the diagram includes a sub-step of applying a logarithmic scale to the diagram built;
   Applying a logarithmic scale to the diagram enables the contrast of the diagram to be improved.
the step of building the diagram includes a sub-step of applying a reduction in the size of the diagram built by a predetermined factor.
   Reducing the size of the diagram enables the calculation time required by the artificial neural network to process the diagram to be reduced.
the method according to the invention includes a step of building the training database, including the following sub-steps of:
   For each non-stationary time signal generated by a training rotating machine, building an initial diagram from the signal;
   For each initial diagram built, standardly normalising the initial diagram built to obtain a training diagram.
      Standard normalisation enables the training database to be homogenised.
the artificial neural network is a convolutional artificial neural network.

A second aspect of the invention relates to a calculator configured to implement the steps of the method according to the invention.

A third aspect of the invention relates to a computer program product comprising instructions which, when the program is executed on a computer, cause the same to implement the steps of the method according to the invention.

A fourth aspect of the invention relates to a computer-readable recording medium comprising instructions which, when executed by a computer, cause the same to implement the steps of the method according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a graph of a non-stationary time signal as a function of time.

FIG. 2 shows a block diagram of a method according to the invention.

FIG. 3 is a diagram obtained at the end of a first step of the method according to the invention.

FIG. 4 shows a confusion matrix of the results provided by an artificial neural network trained during a third step of the method according to the invention.

FIG. 5 shows a diagram obtained at the end of the first step of the method according to the invention, on which the importance of the zones in the decision-making of the artificial neural network trained has been represented by means of a heat map.

### DETAILED DESCRIPTION

The figures are set forth by way of indicating and in no way limiting purposes of the invention.

The present invention relates to a method for diagnosing a part of a rotating machine, the diagnosis being automatic, that is, requiring no human intervention.

By “diagnosing a part of a rotating machine”, it is meant determining the operating state of the part of the rotating machine, an operating state being, for example, a nominal operating state or a defective operating state.

The rotating machine is preferably an engine, for example a piston engine. The rotating machine is preferably included in an aircraft, such as for example of a turbojet engine.

The part is for example one or several gears, a rotor-stator assembly, a rotating shaft, an oil unbalance, a vane wake, a runner wake or one or several bearings.

According to a preferred embodiment, the rotating machine is an engine, and the part is a bearing.

The method according to the invention is based on a non-stationary time signal generated by the rotating machine.

By “non-stationary time signal”, it is meant a physical time signal whose frequency content varies over time.

In the remainder of the description, the terms “non-stationary time signal”, “time signal” or “signal” will be used interchangeably.

The time signal is generated during at least one phase during which a rotation speed of the rotating machine varies as a function of time. The fact that the time signal is non-stationary is due to the fact that the rotation speed of the rotating machine varies during the time signal generation phase.

The signal is measured, for example, by means of a sensor, possibly embedded in the rotating machine, for example an electrical, magnetic, thermal, acoustic or vibration sensor.

Preferably, the sensor is a vibration sensor, in particular an accelerometer.

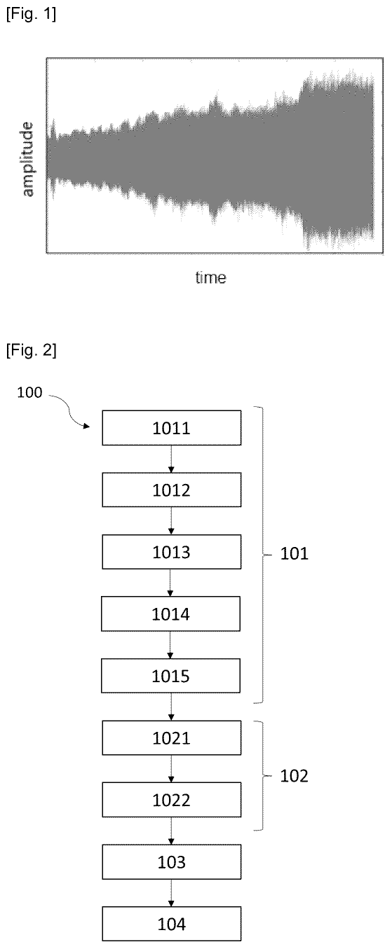

FIG. 1 shows an exemplary non-stationary time signal, the abscissa axis representing time and the ordinate axis representing the amplitude of the signal.

According to a preferred embodiment, the signal is a vibratory signal.

The method according to the invention can be carried out as part of a check at the output of the production line of the rotating machine or during maintenance of the rotating machine.

For example, if the rotating machine is an engine, the signal is, for example, a vibratory signal generated during an acceleration and deceleration phase of the engine during operation.

The method 100 according to the invention includes a plurality of steps, the sequence of which is represented in FIG. 2.

A first step 101 of the method 100 according to the invention is a step 101 of building a diagram from the signal. The first step 101 comprises a plurality of sub-steps.

A first sub-step 1011 of the first step 101 is a sub-step of splitting the signal into a plurality of sub-signals. Splitting is carried out so that each sub-signal is quasi-stationary over the corresponding time interval.

Each time interval, and therefore each sub-signal, is associated with at least one rotation speed of the rotating machine corresponding to the rotation speed taken by the rotating machine over the time interval.

A second sub-step 1012 of the first step 101 is a sub-step of calculating, for each sub-signal, the Fourier transform of the sub-signal, which makes it possible to obtain, for each frequency of the Fourier transform calculated, that is, for each frequency of the passband of the sub-signal, a vibratory energy associated with the frequency in the sub-signal. The vibratory energy therefore corresponds to the frequency amplitude of the sub-signal.

A third sub-step 1013 of the first step 101 is a sub-step of building the diagram.

The diagram is a matrix having a plurality of rows and a plurality of columns. Each row corresponds to a rotation speed taken by the rotating machine over the phase for generating the time signal and each column corresponds to a frequency of the Fourier transform calculated in the second sub-step 1012, divided by a rotation speed taken by the rotating machine over the phase for generating the time signal. The plurality of rows is ordered in ascending order, that is, a first row corresponds to a rotation speed lower than a rotation speed of a second row. Similarly, the plurality of columns is ordered in ascending order.

For each row of the plurality of rows and each column of the plurality of columns, the diagram includes the vibratory energy of the sub-signal associated with the rotation speed of the rotating machine corresponding to the row for the frequency of the Fourier transform corresponding to the column.

The diagram built is therefore two-dimensional and can therefore be assimilated to a greyscale or colour image.

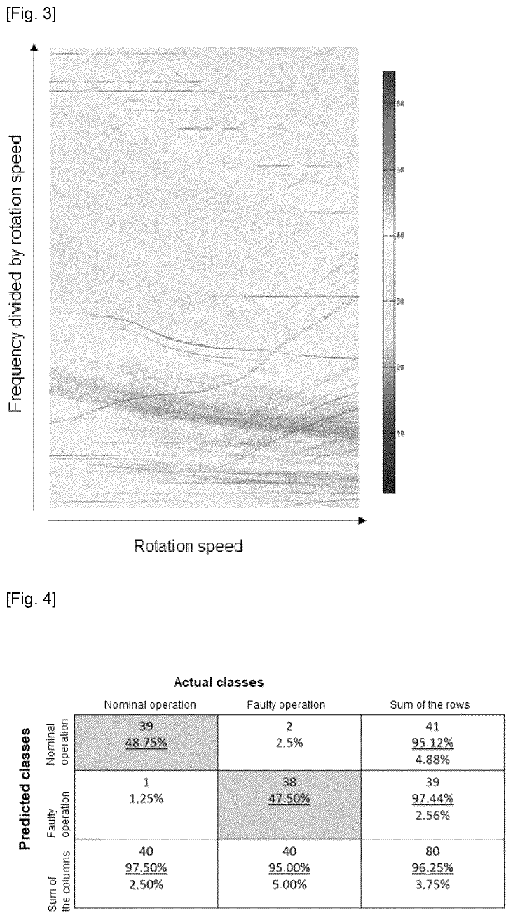

An exemplary built diagram is shown in FIG. 3. Each point or pixel of the diagram built corresponds to a given rotation speed, a given frequency divided by the given rotation speed, and a given vibratory energy whose intensity is represented by a colour defined by a colour scale. Alternatively, the intensity of the vibratory energies can be represented by a grey level defined by a grey level scale.

The diagram built includes, for example, a number of pixels of between two million and twelve million.

According to an embodiment, the first step 101 of the method 100 further comprises a sub-step 1014 of applying a logarithmic scale to the diagram built obtained at the end of the third sub-step 1013.

According to a complementary embodiment to the preceding embodiment, the first step 101 further comprises a sub-step 1015 of reducing the size of the diagram built obtained at the end of the third sub-step 1013 by a predetermined factor. The predetermined factor is for example equal to ten.

The reduction in the size of the diagram built can be carried out by means of a maximum value sub-sampling operation known as “maxpooling”.

The method further comprises a third step 103 of supervisedly training an artificial neural network on a training database, in order to obtain an artificial neural network trained capable of providing a class of operation from a diagram.

The class of operation is included in a set of classes of operation including at least one class of nominal operation and one class of defective operation. The set of classes of operation may further include an at-risk class of operation.

Supervised training, otherwise known as supervised learning, makes it possible to train an artificial neural network for a predefined task, by updating its parameters so as to minimise a cost function corresponding to the error between the piece of output data provided by the artificial neural network and the true piece of output data, that is, what the artificial neural network should output in order to fulfil the predefined task on some piece of input data.

The training database therefore includes input data, each associated with a piece of output data.

The input data are training diagrams, each training diagram being built from a non-stationary time signal generated by a training rotating machine and each associated with a class of operation from the set of classes of operation, the classes of operation therefore being the output data.

Each training rotating machine is of the same type as the rotating machine, that is, if the rotating machine is an aircraft engine, each training rotating machine is also an aircraft engine.

Supervised training of the artificial neural network therefore consists in updating the parameters of the artificial neural network so as to minimise a cost function corresponding to the error between the prediction of the class of operation provided by the artificial neural network from a training diagram of the training database and the class of operation associated with said training diagram of the training database.

The cost function results, for example, from the compounding of the binary cross-entropy function by the sigmoid function.

The cost function is minimised, for example, using a descent algorithm of the stochastic gradient with back-propagation through time (BPTT).

The artificial neural network is preferably a convolutional artificial neural network.

The artificial neural network is, for example, the VGG19 artificial neural network.

According to an embodiment, the method 100 comprises a second step 102 of building the training database, carried out prior to the third step 103, comprising a plurality of sub-steps.

A first sub-step 1021 of the second step 102 consists, for each signal generated by a training rotating machine, in building an initial diagram from the signal.

The first sub-step 1021 of the second step 102 is carried out in the same way as the first step 101, that is, by splitting the signal into sub-signals, calculating the Fourier transform of each sub-signal to obtain vibratory energies and building the initial diagram using the vibratory energies obtained.

A second sub-step 1022 of the second step 102 consists, for each initial diagram obtained at the end of the first sub-step 1021, in applying a standard normalisation, otherwise known as z-score normalisation, to the initial diagram in order to obtain a training diagram.

The method comprises a fourth step 104 of using the artificial neural network trained on the diagram built obtained at the end of the first step 101, to obtain a class of operation and therefore a diagnosis for the part of the rotating machine.

Experiments have been conducted to test the results provided by the artificial neural network trained in the case where the rotating machine is an aircraft engine and the part to be diagnosed is a bearing of the aircraft engine.

Each engine in a set comprising 1665 engines has performed an identical manoeuvre on the test bench. This manoeuvre is an acceleration of the engine followed by a deceleration of the engine. During this manoeuvre, a non-stationary time vibratory signal has been measured by an accelerometer included in the engine.

A database has been constituted according to the second step 102 of the method 100 according to the invention from the 1665 measured vibratory signals, to obtain 1665 diagrams and a class of nominal operation or a class of defective operation has been associated manually with each diagram obtained by experts.

All the 1665 diagrams and their associated classes constitute an annotated database which has been divided into three parts: a training database, a validation database and a test database according to the proportions represented in the table below:

| | Diagrams of engines | Diagrams of | |
|---|---|---|---|
| | in nominal operation | defective engines | Total |
| Training database | 1342 | 203 | 1545 |
| Validation database | 20 | 20 | 40 |
| Test database | 40 | 40 | 80 |
| Total | 1402 | 263 | 1665 |

As part of the experiments, the artificial neural network used is the VGG19 artificial neural network.

The artificial neural network has been trained in a supervised manner on the training database and the training has been validated by means of the validation database.

In order to evaluate the performance of the artificial neural network, the diagrams included in the test database have been provided to the artificial neural network trained and several quality criteria have been evaluated by comparing, for each diagram in the test database, the class of operation provided by the artificial neural network for said diagram and the class of operation associated with said diagram in the test database.

The quality criteria evaluated are as follows:
The accuracy of the results, that is, the number of engines to which the artificial neural network has assigned the correct class divided by the total number of engines;
The rate of detection of defective engines;
The false alarm rate, a false alarm in this case being the classification of a defective engine in the category of engines with nominal operation.

The results are shown in the following table:

| | |
|---|---|
| Accuracy of results | 96.25% |
| Rate of detection of defective engines | 95% |
| False alarm rate | 2.5% |

The quality criteria set forth in the previous table can also be represented in the form of a confusion matrix, as illustrated in FIG. 4. Each column of the matrix corresponds to the true class of operation, that is, the class of operation included in the test database, and each row of the matrix corresponds to the class of operation provided by the artificial neural network.

The confusion matrix can then be read as follows:
vertically, for the first column, of the 40 engines in nominal operation, 39 have been estimated by the artificial neural network as engines in nominal operation and 1 engine has been estimated as defective (that is, a false negative),
vertically, for the second column, of the 40 defective engines, 2 have been estimated by the neural network as engines in nominal operation (that is, 2 false positives) and 38 have been estimated as defective,
horizontally, for the first row, of the 41 engines estimated by the neural network as being in nominal operation, 2 are actually defective engines,
horizontally, for the second row, of the 39 engines estimated by the artificial neural network as being defective, 1 is actually an engine with nominal operation,
diagonally, from top left to bottom right, of the 80 engines, 77 (39+38) have been correctly estimated by the artificial neural network, giving an accuracy of 96.25%.

The zones of interest used by the artificial neural network to make its decision to assign a class of operation have been visualised using a module called Grad-Cam, which produces heat maps highlighting these zones of interest.

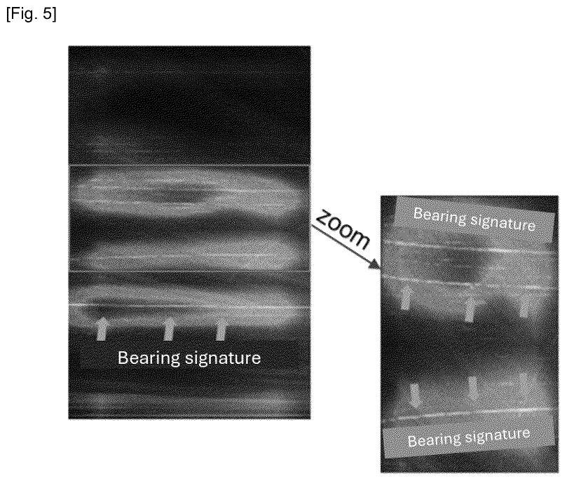

FIG. 5 represents a diagram to which the Grad-Cam module has been applied. The zones highlighted correspond to signatures of damage to engine bearings, identified manually by human operators, which means that the artificial neural network correctly identifies signatures of damage to engine bearings in order to make the decision to assign a class of defective operation.

1. A method for automatically diagnosing a part of a rotating machine carried out on based on a non-stationary time vibratory signal generated by the rotating machine during at least one phase during which a rotation speed of the rotating machine varies as a function of time, the method comprising:
building a diagram from the signal, comprising the following sub-steps of:
splitting the signal into a plurality of sub-signals, each sub-signal corresponding to a time interval associated with at least one rotation speed of the rotating machine and being quasi-stationary over the time interval;
for each sub-signal, calculating the Fourier transform of the sub-signal in order to obtain a vibratory energy for each frequency of the Fourier transform of the sub-signal;
building the diagram, the diagram being a matrix having a plurality of rows each corresponding to a rotation speed of the rotating machine, ordered in ascending order, and a plurality of columns each corresponding to a frequency of the Fourier transform divided by a rotation speed of the rotating machine, ordered in ascending order, the matrix comprising, for each row and each column, the vibratory energy of the sub-signal corresponding to the rotation speed of the rotating machine of the row for the frequency of the Fourier transform of the column;
supervisedly training an artificial neural network to obtain an artificial neural network trained capable of providing, from the diagram, a class of operation included in a set of classes of operation including at least one class of nominal operation and one class of defective operation, the artificial neural network being trained on a training database including a plurality of training diagrams, each training diagram being built from a non-stationary time signal generated by a training rotating machine of a same type as the rotating machine and being associated with one class of operation from the set of classes of operation;
using the trained artificial neural network on the diagram built to provide a class of operation of the rotating machine.

2. The method according to claim 1, wherein the signal is a vibratory signal.

3. The method according to claim 1, wherein the part is a bearing included in the rotating machine.

4. The method according to claim 3, wherein the rotating machine is an engine.

5. The method according to claim 1, wherein the step of building the diagram includes a sub-step of applying a logarithmic scale to the diagram built.

6. The method according to claim 1, wherein the step of building the diagram includes a sub-step of reducing the size of the diagram built by a predetermined factor.

7. The method according to claim 1, comprising a step of building the training database, including the following sub-steps of:
for each non-stationary time signal generated by a training rotating machine, building an initial diagram from the signal;
for each initial diagram built, standardly normalising the initial diagram built to obtain a training diagram.

8. A calculator configured to implement the steps of the method according to claim 1.

9. (canceled)

10. A non-transitory computer-readable storage medium comprising instructions which, when executed by a computer, cause the same to implement the steps of the method according to claim 1.
